(19) United States
(12) Patent Application Publication
(10) Pub. No.: US 2023/0108177 A1
(43) Pub. Date: Apr. 6, 2023

(54) Hardware-Aware Progressive Training Of Machine Learning Models

(71) Applicant: Google LLC, Mountain View, CA (US)

(72) Inventors: Sheng Li, Cupertino, CA (US); Mingxing Tan, Sunnyvale, CA (US); Norman Paul Jouppi, Palo Alto, CA (US); Quoc V. Le, Sunnyvale, CA (US); Liqun Cheng, Palo Alto, CA (US); Ruoming Pang, New York, NY (US); Parthasarathy Ranganathan, San Jose, CA (US)

(21) Appl. No.: 17/899,728

(22) Filed: Aug. 31, 2022

Related U.S. Application Data
(60) Provisional application No. 63/252,743, filed on Oct. 6, 2021.

(51) Int. Cl. G06N 20/00

(52) U.S. Cl. CPC G06N 20/00

(57) ABSTRACT

Aspects of the disclosure provide for hardware-aware progressive training of machine learning models. A training system trains a model in accordance with a training process and different values specified in a training schedule for both hardware-level and model-level performance settings. Hardware-level performance settings can cause hardware features of computing resources used to train the model to be enabled, disabled, or modified at various points during training. Model-level performance settings can take on a variety of values to adjust characteristics of the machine learning model being trained or of the training process, during different stages of training. The training system can identify and apply complementary values of hardware- and model-level performance settings to generate training schedules that improve model training speed at earlier stages of training, while improving model quality at later stages of training.

### CROSS REFERENCE TO RELATED APPLICATIONS

The present application claims the benefit of the filing date of U.S. Provisional Patent Application No. 63/252,743 filed Oct. 6, 2021, the disclosure of which is hereby incorporated herein by reference.

### BACKGROUND

Neural networks are machine learning models that include one or more layers of nonlinear operations to predict an output for a received input. In addition to an input layer and an output layer, some neural networks include one or more hidden layers. The output of each hidden layer can be input to another hidden layer or the output layer of the neural network. Each layer of the neural network can generate a respective output from a received input according to values for one or more model parameters for the layer. The model parameters can be weights and/or bias values that are determined through a training process to cause the neural network to generate accurate output when evaluated using a performance or loss function.

Increasing the speed of the training process is critical to improving machine learning models. There exist a number of platform/hardware optimizations that can provide trade-offs between training speed and quality. However, because the quality of machine learning models is so important, hardware techniques are not applied to speed up the training process unless there is no loss in quality, leading to many performance optimization opportunities becoming unavailable.

### BRIEF SUMMARY

Aspects of the disclosure provide for hardware-aware progressive training of machine learning models. Progressive learning or training is a technique for training machine learning models by adjusting the model or a training process for training the model, while training the model. A progressive training system can generate and apply different values of both model-level and hardware-level performance settings at different stages of a training process to maintain model quality according to predetermined minimum thresholds while improving the speed at which the progressive training system trains the model.

Model-level performance settings correspond to characteristics of the machine learning model being trained or parameters of the training process applied. The training system can adjust to different values of model-level performance settings during training, which do not depend on the computing resources used to train the model. Hardware-level performance settings correspond to hardware features of computing resources used to train the machine learning model. Hardware-level performance settings can take on different values to enable, disable, or modify different hardware features during training applied by the training system.

The training system leverages existing hardware features to adjust both hardware- and model-level performance settings during training of a machine learning model at different stages of the training process. The training system can identify and apply complementary values of hardware- and model-level performance settings to generate training schedules that improve model training speed at earlier stages of training, while maintaining or improving model quality at later stages of training.

Aspects of the disclosure provide for improving training speed by using available computing resources and their respective available hardware features, such as hardware parallelism, operand numerical precision, and varying levels of intra- and inter-device communication, to improve the speed at which a model is trained versus progressive training alone. The training system can be scaled as needed to leverage hardware features for computing resources of a computing platform of connected devices, to further improve the speed at which a training process is performed.

The training system can generate and store training schedules to be queried later for reuse in training other machine learning models or a previously trained model. The training system can use portions of previously generated training schedules for retraining models on new training data, for example training schedules focusing on model quality improvements before increasing training speed.

Aspects of the disclosure also provide for searching for neural architectures that can be modified during training according to a training schedule, for example with less computational overhead over modifying other candidate architectures, and/or to take more advantage of hardware-aware progressive training to realize increased training speeds over other architectures.

An aspect of the disclosure is directed to a system, including one or more processors configured to receive a request to train a machine learning model; receive, by the one or more processors, a training schedule specifying a plurality of values for one or more hardware-level performance settings and one or more model-level performance settings; train the machine learning model in accordance with a training process, one or more hardware-level performance settings, and one or more model-level performance settings set to different values of the plurality of values of the training schedule at different points in time during training; and in response to receipt of the request, send the trained machine learning model to one or more computing devices.

An aspect of the disclosure is directed to a method, including: receiving, by one or more processors, a request to train a machine learning model, the one or more processors configured to train the machine learning model in accordance with one or more hardware-level performance settings and one or more model-level performance settings; receiving, by the one or more processors, a training schedule specifying a plurality of values for the one or more hardware-level performance settings and the one or more model-level performance settings; training, by the one or more processors, the machine learning model in accordance with a training process and the one or more hardware-level performance settings and one or more model-level performance settings set to different values of the plurality of values of the training schedule at different points in time during training; and in response to receiving the request, sending, by the one or more processors, the trained machine learning model to one or more computing devices.

An aspect of the disclosure is directed to one or more non-transitory computer-readable storage media encoded with instructions that when executed by one or more processors configured to train a machine learning model in accordance with one or more hardware-level performance settings and one or more model-level performance settings, cause the one or more processors to perform operations including: receiving a request to train a first machine learning model; receiving a training schedule specifying a plurality of values for the one or more hardware-level performance settings and the one or more model-level performance settings; training the first machine learning model in accordance with a training process and the one or more hardware-level performance settings and one or more model-level performance settings set to different values of the plurality of values of the training schedule at different points in time during training; and in response to receiving the request, sending the trained first machine learning model to one or more computing devices.

Aspects of the disclosure can include one or more of the following features. In some examples, an aspect of the disclosure includes all of the following features, in combination.

The one or more model-level performance settings can include one or more of: an input data size for input data to the machine learning model, one or more model hyperparameters specifying the size or shape of the machine learning model, and one or more training process hyperparameters modifying the training process implemented by the one or more processors for training the machine learning model.

The one or more hardware-level performance settings can include settings for adjusting intra- or inter-data communication between the one or more processors.

The one or more processors can include a plurality of processors logically or physically grouped into a plurality of groups, and the one or more hardware-level performance settings can include settings for the rate of inter-data communication between processors in different groups.

The one or more hardware-level performance settings can include settings for adjusting numerical precision of operations performed by the one or more processors while training the machine learning model in accordance with the training process.

In training the machine learning model, the one or more processors can be further configured to: set the one or more hardware-level and model-level performance settings to a first values of the plurality of values of the training schedule; and at a first point in time after initiation of the training of the machine learning model, adjust the one or more hardware-level and one or more model-level performance settings to second values of the plurality of values different from the first values.

In receiving the training schedule, the one or more processors can be further configured to generate a training schedule using a training schedule machine learning model, the training schedule machine learning model: trained to generate training schedules from one or more input parameters at least partially describing one or more of the machine learning model, the machine learning task, and computing resources available for training the machine learning model, and trained using one or more training examples of training schedules, each example training schedule labeled with respective data at least partially describing one or more respective input parameters used to generate the example training schedule, the training speed, and the model quality of a respective machine learning model trained in accordance with the training process and the example training schedule.

The machine learning model can be a neural network having a neural architecture selected from a plurality of candidate neural architectures, the selection of the neural architecture based at least partially on comparison of estimated respective training speeds and respective model qualities of neural networks: trained in accordance with the training process and a respective training schedule, and having a respective candidate neural architecture of the plurality of candidate neural architectures.

In receiving the training schedule, the one or more processors can be further configured to: send a query to one or more memory devices storing a plurality of candidate training schedules, the query comprising data at least partially describing one or more of the machine learning model, the machine learning task, and computing resources available for training the machine learning model; and receive the training schedule from the plurality of candidate training schedules in response to the query.

An aspect of the disclosure is directed to a method, including performing, by one or more processors, a neural architecture search over a plurality of candidate neural architectures to identify a target neural architecture, including: estimating at least the training speed and model quality of a first neural network having a first candidate neural architecture of the plurality of candidate neural architectures and trained in accordance with a training process and one or more hardware-level performance settings and one or more model-level performance settings set to different values of a first plurality of values during training, and selecting the first candidate neural architecture as the target neural architecture based at least on a comparison of the estimated training speed and estimated model quality of the first neural network to respective estimated training speeds and respective estimated model qualities of one or more second neural networks: each having a respective second candidate neural architecture, and trained in accordance with the training process and the one or more hardware-level performance settings and the one or more model-level performance settings set to different values of a respective second plurality of values during training.

The method can further include training, by the one or more processors, the first neural network in accordance with a third plurality of values of a training schedule; and sending, by the one or more processors, the trained first neural network to one or more computing devices.

### BRIEF DESCRIPTION OF THE DRAWINGS

FIG. 1 is a block diagram of an example training system, according to aspects of the disclosure.

FIG. 2 is a flowchart of an example process for hardware-aware progressive training of a machine learning model according to aspects of the disclosure.

FIG. 3A is a flowchart of an example process for training a machine learning model to generate training schedules for hardware-aware progressive training according to aspects of the disclosure.

FIG. 3B is a flowchart of an example process for querying and applying a pre-generated training schedule from one or more memory devices storing multiple training schedules according to aspects of the disclosure.

FIG. 4 is a flowchart of an example process for searching for neural architectures, according to aspects of the disclosure.

FIG. 5 is a block diagram of an example computing environment implementing the example training system according to aspects of the disclosure.

### DETAILED DESCRIPTION

### Overview

Aspects of the disclosure provide for hardware-aware progressive training of machine learning models. Hardware-aware progressive training refers to the application of a variety of different values to both model-level and hardware-level performance settings during the training of a machine learning model, which are adjusted to different values over the course of training. A training system can generate and apply a training schedule specifying multiple values of model-level and hardware-level performance settings applied at different points during training A training system configured for hardware-aware progressive training as described herein can improve the speed at which the training system trains the model during earlier points of the training process, as well as improve the model quality of the model being trained during later points of the training process, over other approaches in which hardware-aware progressive training is not applied.

Hardware-level performance settings can include settings for adjusting the performance of computing resources used to train the machine learning model. Values for hardware-level performance settings can be adjusted for enabling, disabling, or modifying certain hardware features available on computing resources. Computing resources can be any of a variety of combinations of computing devices and memory devices, which for example can be part of a computing platform. The computing platform can logically organize how devices communicate among one another, the organization of which can also be modified through different values of corresponding hardware-level performance settings.

These hardware features can be selectively applied by the training system to adjust the performance of the computing resources in executing operations as part of a training process. For example, hardware features applied in accordance with different values of corresponding hardware-level performance settings can cause the computing resources to execute the operations faster, measured in processing cycles, clock time, etc., at the cost of accuracy in performing those operations. Other values for hardware-level performance settings cause the computing resources to execute operations such as different numerical calculations accurately, at the cost of additional processing cycles, processing/memory utilization, and/or time, etc. As a result, the model trained will have improved model quality, for example measured in model accuracy or recall rate.

Model-level performance settings applied at different values by the training system modify the machine learning model or the training process itself. Model-level performance settings do not affect the hardware or hardware features used by the training system during training, but depending on values taken for these settings, can affect the quality of the resulting trained model and the speed at which the model is trained. Hardware aware progressive training provides for more effective use of available configurations of both model and hardware level features available on a platform training a model, to reach higher training speeds and sustained or improved model quality at different stages of training that may otherwise not be reached through progressive training alone.

The training system can train a machine learning model over multiple stages. A training stage can be defined as a number of training steps, with each training step representing a full forward and backward pass to update model parameter values based on calculated error. The number of training steps in a training stage can vary, for example from thousands to millions. The number of training steps can vary based on, for example, the total number of training steps for all of the stages of training and/or the size of the training dataset. In some examples, stages can be defined as periods of time shorter than the total training time for training the model, a number of epochs or number of times an entire training set is processed by the model, and/or by certain model performance milestones achieved, such as a threshold recall rate or any threshold based on a metric for measuring model accuracy.

For example, the training system can apply values for model-level performance settings corresponding to smaller network sizes, smaller input sizes, less regularization and/or less normalization, etc., which can result in faster training at the cost of model quality. The training system can apply model-level performance settings with different values corresponding to larger network sizes, larger input sizes, more regularization and/or more normalization, which can result in slower training due to performance overhead, but higher model quality.

Training speed can be measured, for example, in the number of processing cycles required to train a machine learning model through an entire epoch of training data, by how long it takes to process an individual training example or mini-batch of training examples, and/or by the number of processing cycles required to complete one or more stages of training Model quality can be measured, for example, according to how well a machine learning model performs the task it is being trained to perform. Example metrics for measuring model quality can include recall rate, a loss between a model prediction and a corresponding ground-truth label, model accuracy, and/or model precision in performing a machine learning task.

During training, the training system applies different values for both hardware- and model-level performance settings, and adjusts those values at different points during training to achieve different trade-offs between training speed and model quality. Example points at which the training system applies different values include the beginning of different stages of training defined, for example, according to time, number of training iterations, or meeting minimum milestones for model quality, etc. Other examples include time-based intervals, such as minute-by-minute or hour-by-hour intervals passing during training.

Based on a training schedule as described herein, the training system can initially apply values to the performance settings to adjust training of the model to favor training speed over model quality to learn high-level patterns and relationships between training examples and their labels at higher training speeds. As training progresses, the training system gradually adjusts the values of the performance settings to prefer model quality improvements with speed overhead, according to a rate of change that can be specified in the training schedule. As training reaches its final stage, the training system applies values of the hardware- and model-level performance settings to emphasize model quality with little to no priority given to reducing performance overhead, resulting in reduced training speed.

The training system can generate training schedules with complementary values for various hardware-level and model-level performance settings. Complementary values for model-level performance settings allow certain hardware features to be applied more efficiently, for example resulting in fewer processing cycles to execute operations as part of implementing a training process, or allowing for optimization processes to improve model quality. For instance, values of model-level performance settings for enabling second order optimization methods during training complement values for hardware-level performance settings corresponding to performing operations with lower numerical precision, for example using less than 64-bit floating-point or integer precision.

The training system can identify complementary values of performance settings by the training system as part of generating training schedules. For example, the training system can implement a training schedule machine learning model trained to generate training schedules from one or more input parameters at least partially describing one or more of the machine learning model to be trained on a set of computing resources, the machine learning task, and the set of computing resources available for training the model. In some examples, the training system can search a space of candidate training schedules according to different optimization parameters or search criteria, as described herein.

Examples of complementary values include values for lower resolution, weaker regularization, and smaller models, paired with hardware-level performance settings for local node communication and gradient accumulation and lower precision computation. At later stages of training, higher resolution, stronger regularization, and larger models may be paired with hardware-level performance values for global communication and gradient accumulation and higher precision computation.

As better performing training schedules are identified, for example by observing faster training speeds and/or higher model qualities at different points during training, these training schedules can be provided as additional examples for retraining the training schedule machine learning model or updating search criteria for searching for training schedules given a set of input parameters. Generally, higher performing training schedules will include complementary values of hardware- and model-level performance settings over lower performing training schedules.

Aspects of the disclosure provide for at least the following technical advantages. Machine learning models can be trained faster, for example in less clock time and/or using fewer processing cycles, versus other models not trained using hardware-aware progressive training. At later stages of training, model quality can be approved by gradually adjusting performance settings to favor model quality at the cost of performance overhead. Improved model quality of a trained machine learning model can improve the function of computing devices deploying the model at inference, for example because responses to queries or requests to process data on the model can be generated more accurately.

Training can be performed more efficiently, for example using more of available features to accelerate operations as part of implementing a training process, versus not using a training schedule as described herein. The training system is configured to generate training schedules with complementary values to reduce or avoid conflicting values of hardware- and model-level performance settings which may inhibit training.

Training schedules applied and generated by the training system are tailored according to available hardware features for computing resources designated for training a model using a training process and a given training schedule. For instance, a computing platform may include a variety of different computing devices available for training a machine learning model, with different devices varying in terms of hardware features available and/or data processing capability.

The training system can make more efficient use of computing resources allocated for training a particular machine learning model, because the training system can apply a training schedule with hardware-level performance settings values based on the particular hardware features and processing capability available by the allocated computing resources. The training system can apply the same training schedule to the same set of computing resources at different scales, so as to not add additional processing overhead to platform operations for scaling computing resources up or down during or in-between training sessions.

The overhead in adjusting model-level and hardware-level performance settings incurs a small or negligible amount of overhead for purposes of training and executing a machine learning model. As a result, changes can be applied often to both model-level and hardware-level performance settings to vary the trade-off between model quality and training speed. Despite the large number of potential combinations of model-level and hardware-level performance settings, aspects of the disclosure provide for searching a space of candidate training schedules to identify combinations of model-level and hardware-level performance settings for improving or sustaining model quality with faster training speeds over other approaches in which hardware-aware progressive training is not applied.

### Example Systems

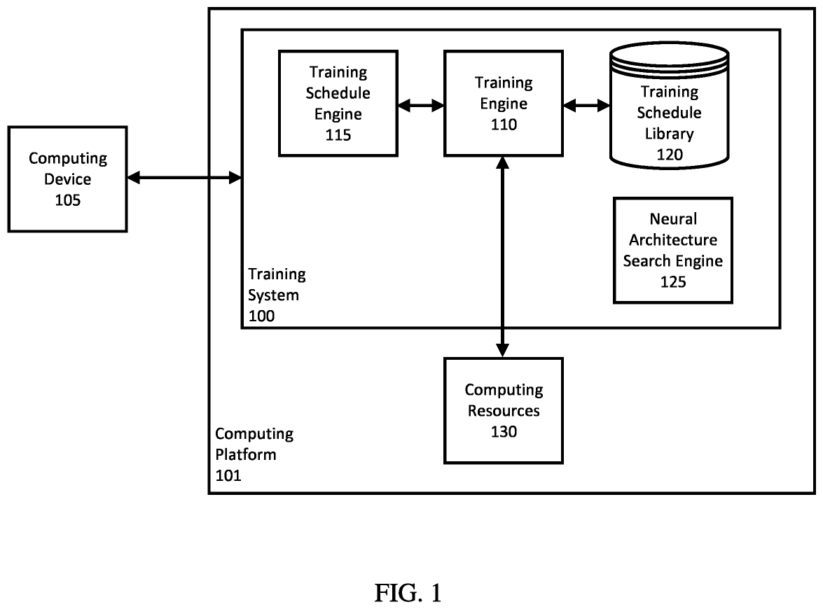

FIG. 1 is a block diagram of an example training system 100, according to aspects of the disclosure. The training system 100 can be implemented on one or more computing devices in one or more physical locations. The training system 100 is shown in FIG. 1 as part of a computing platform 101. The computing platform 101 can be a collection of computing devices communicating with one or more other computing devices over a network, for example computing device 105.

The training system 100 includes a training engine 110, and can also include a training schedule engine 115, and a training schedule library 120. In some examples, the training system 100 can also include a neural architecture search engine 125.

The training system 100 is configured to receive requests for training a machine learning model, for example from the computing device 105. As an example, the computing device 105 can send a request, for example over some interface, such as an API or web interface on a browser or mobile application presented on a display of the computing device 105, to the training system 100.

The computing device 105 can be a user computing device operated by a user, and/or a device configured to automatically communicate with the training system 100. For example, the computing device 105 can be configured to receive and deploy a trained machine learning model. The computing device 105 can be further configured to receive requests from other computing devices (not shown) for processing input by the deployed model to generate respective output data. The other computing devices may be connected to the computing device 105, separately or as a part of a network connecting the platform 101 with the computing device 105.

The request from the computing device 105 can specify input parameters at least partially describing the machine learning model, the machine learning task, and/or the computing resources available for training the model. Input parameters for describing the machine learning model can include a model type, such as a neural network, a support vector machine, a regression model, etc. Input parameters can also include specific characteristics of the desired machine learning model, such as a neural network having a particular width or depth.

Input parameters can also specify the type of machine learning task the machine learning model will be trained to perform, such as a regression or a classification task. Example machine learning tasks are provided herein, and in general a machine learning task can be defined for approximating a function between a set of input and corresponding output, which is learned by the machine learning model trained to perform the task. The input parameters can also further specify a sub-type of a machine learning task for the machine learning model to be trained to perform, such as binary classification, multi-class classification, linear regression, logistic regression, etc.

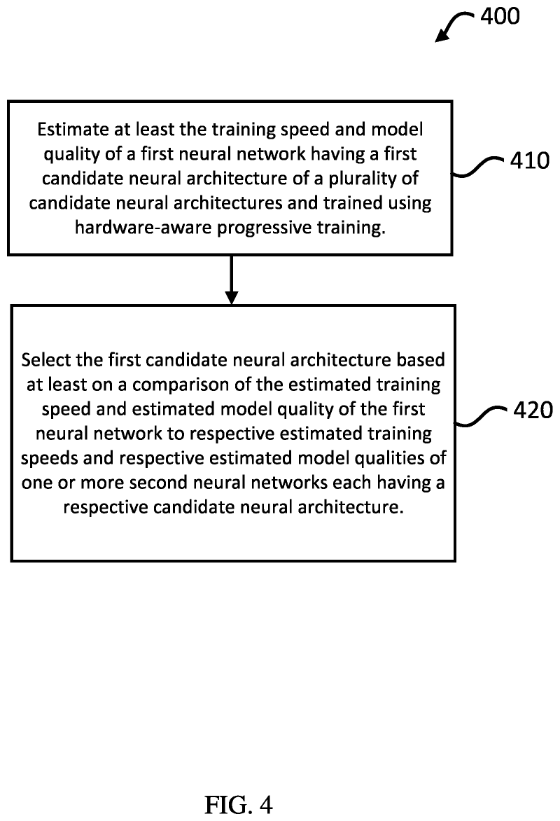

The training system 100 can be configured to automatically select a type of machine learning model if a task is specified in the input parameters, but not a model type. For example, the training system 100 may be part of an automatic machine learning (AutoML) system (not shown in FIG. 1). The AutoML system can be configured to automatically select a machine learning model to implement based on input parameters specifying a task to be performed, optionally among other input parameters. Even if the input parameters specify a model type, in some examples the AutoML system implementing the training system 100 can be configured to suggest one or more model types based on the other received parameters. As described in more detail with respect to FIG. 4, the training system 100 in some examples implements a neural architecture search (NAS) engine 125 configured to identify neural architectures for training neural networks having those architectures and which can be trained using hardware-aware progressive training.

A neural architecture refers to a set of values describing the shape or topology of a neural network. Example values that may be part of a neural architecture include, for example, the number of layers of the architecture, the width of each layer, the number of nodes or neurons at each layer, the types of operations performed at each layer given a set of input, and the types of activation functions applied for one or more of the network layers. Each neural network is said to have a respective neural architecture.

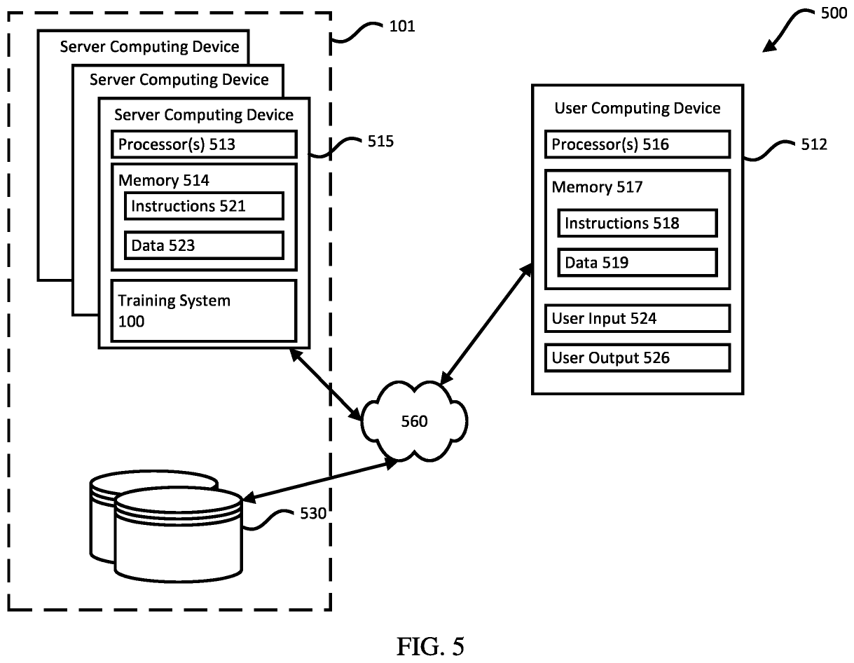

Input parameters can also specify the computing resources on which the training system 100 is to train the machine learning model. Computing resources 130 of the computing platform 101 can include a variety of different computing devices, including processors and memory devices of a variety of different types and configurations, as described herein with reference to FIG. 5. The computing resources 130 can include a number of computing devices with various hardware features for improving data processing or storage on the computing devices. These hardware features can be enabled, disabled, or modified, according to different values of hardware-level performance settings adjusted by the training system 100.

The input parameters can specify how much, what kind, and/or which specific computing resources should be used by the training system 100 in training the machine learning model. For example, the computing device 105 may be associated with a user who has been allocated a portion of the computing resources 105. In other examples, the platform 101 may provide more or fewer computing resources, for example measured in a length of time of availability, a number of processing cycles, or more or fewer devices of different processing speeds or processing capabilities. Processing capability can be measured, for example, in clock speed, data bandwidth, cache memory size, etc. For example, a request may specify the use of graphics processing units (GPUs) for accelerating the training of a machine learning model, versus the use of other, less-specialized devices, such as central processing units (CPUs).

The request can also specify training data or the location of training data to be used for training the machine learning model. For example, the training data can be stored on one or more computing devices of the platform 101, which may be the same or different as the devices implementing the training system 100. The training data can include, for example, one or more training examples of input the model is being trained to process to generate a respective output. Some or all of the training examples may include labels of ground-truth output corresponding to the labeled examples.

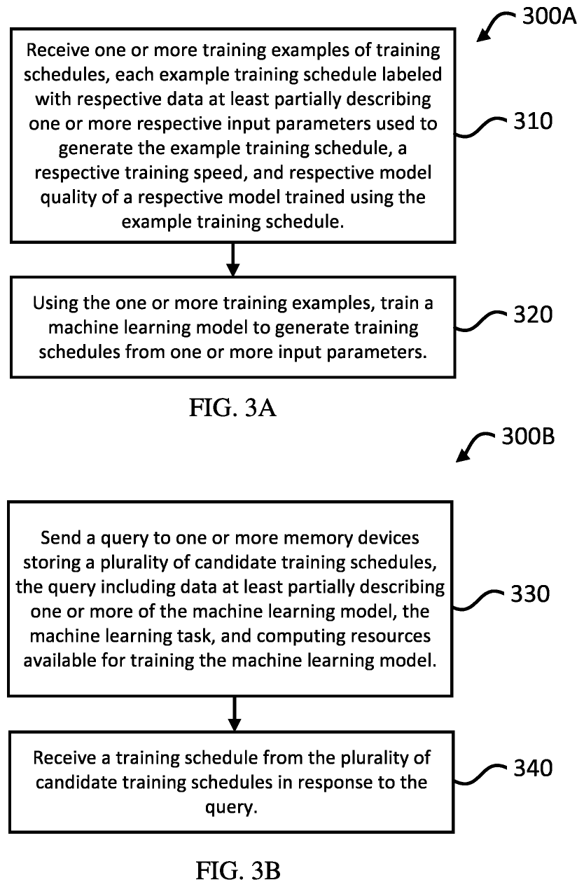

The training engine 110 receives the request from the computing device 105, and receives a training schedule specifying values for hardware-level and model-level performance settings for training a machine learning model according to the request. As described in more detail with reference to FIGS. 3A-B, the training engine 110 can receive the training schedule, for example from the training schedule engine 115 configured to generate a training schedule according to aspects of the disclosure. In other examples, the training engine 110 receives a training schedule by querying the training schedule library 120 storing a collection of pre-generated training schedules.

The training engine 110 implements a training process for training the machine learning model over a period of training time. A training process can include any set of operations for training a machine learning model, which can be repeated one or more times over the period of training time. The training process can vary, for example depending on the nature of the type of model to be trained and/or the machine learning task the model is being trained to perform. Example processes can be based on supervised, unsupervised, or semi-supervised learning approaches. For example, the training engine 110 can be configured to train the machine learning model as a neural network, using backpropagation with gradient descent plus updating one or more weights or model parameter values for the machine learning model in accordance with the computed gradients and optionally one or more other parameters. As described herein, some model-level performance settings set to different values can cause the training engine 110 to modify the training process for training the model.

The training engine 110 can also be configured, as part of training, to perform various optimization processes, for example including adaptive moment estimation (Adam) optimization, stochastic or mini-batch gradient descent, gradient descent with momentum, as well as processes for reducing overfitting in a trained model, for example using dropout.

Other training processes, for example based on different model architectures such as models based on clustering or support vector machines, can also be applied by the training engine 110. In addition, other types of training processes, for example processes based on unsupervised or semi-supervised approaches, can also be executed by the training engine 110 to train a machine learning model according to aspects of the disclosure.

The period of training time can be defined according to one or more termination criteria, which can be provided, for example, as additional input parameters as part of a received request, or predetermined. The training engine 110 stops training when termination criteria are met. The criteria can be, for example, a maximum number of iterations of a training process implemented by the training engine 110, a maximum amount of time passing since the beginning of training, meeting minimum model quality performance thresholds by the trained model, and/or not meeting minimum predetermined improvements to model quality after a certain number of iterations or time has passed.

The training system 100 can train a machine learning model over multiple stages. A training stage can correspond to a number of training steps, with each training step representing a full forward and backward pass to update the model parameters values based on calculated error. The number of training steps in a training stage can vary, for example from thousands to millions. The number of training steps can vary based on, for example, the total number of training steps for all of the stages of training and/or the size of the training dataset. In some examples, stages can be defined as periods of time shorter than the total training time for training the model, a number of epochs or number of times an entire training set is processed by the model, and/or by certain model performance milestones achieved, such as a threshold recall rate or any threshold based on a metric for measuring model accuracy.

At each stage, the training engine 110 can apply different values for hardware- and model-level performance settings for adjusting the training process during that stage. Hardware-level and model-level performance settings can take on a range of values with varying trade-offs between training speed and model quality of the trained machine learning model. The training engine 110 can be configured to perform a combination of hardware- and model-level training optimizations together, and to adjust values for both hardware- and model-level performance parameters to achieve different balances between training speed and model quality of the resulting trained model. The training schedule can specify a rate at which values are adjusted for various hardware- and model-level performance settings. For example, if the values are numerical and beginning at one end of a range of values favoring training speed over model quality, then the training schedule can specify a rate at which values for a particular performance setting is adjusted to transition to values favoring model quality over training speed, or vice versa.

At earlier stages of training, the training schedule can specify hardware- and model-level performance settings favoring higher training speed at the cost of model quality. The training schedule can include a number of intermediate values for both hardware- and model-level performance settings to transition the training process performed by the system to favor model quality over training speed. The training schedule specifies points at which intermediate values should be applied to the performance settings, and the training system is configured to apply values for those settings at the specified points. These points can be the beginning of subsequent stages of training, and/or intervals according to other conditions, such as time. For example, the training schedule may specify different values for performance settings on a minute-by-minute interval. At later stages of training, the training schedule can specify values or schemes for hardware- and model-level performance settings that favor higher model quality at the cost of lower training speed.

The range of values for the various hardware-level and model-level performance settings varies at least in accordance with the types of performance settings available during training. For example, one model-level performance setting the learning rate for training a machine learning model. Learning rate adjustments can be initially quite small, for example 0.1-0.01. After a certain number of stages or training steps, the learning rate can be stepped down by some amount, for example by 10 times its current value.

Another example model-level performance setting is regularization. For performance settings such as regularization, in which the performance setting involves different types or categories of optimization as opposed to adjusting numerical values, a value for a performance setting can correspond to a type of scheme covered by the performance setting. In the case of model regularization, such as data augmentation, the method for augmentation can change from simple distortion to more advanced blurring and distortion, depending on different model-level performance setting values.

The range of values for various different hardware-level and model-level performance settings can be integers. As another example, a hardware-level performance setting can be a communication radius for communicating data, such as gradients, between chips, nodes, or other devices training a machine learning model. Initially, the communication radius may be small, for example two by two, for communicating among local devices adjacent to one another. The communication radius can be adjusted to increase, for example sixteen by sixteen or larger, to communicate with hundreds or thousands of chips across different hardware interconnects, within a datacenter, and/or across datacenters.

The training engine 110 is configured to cause the computing resources 130 to perform operations for training the machine learning model in accordance with current values of hardware- and model-level performance settings.

For example, the training engine 110 can generate a program or sequence of instructions, which when executed by the computing resources 130, causes the computing resources 130 to execute operations in accordance with values for performance settings specified in the program or sequence of instructions. In some examples, the training engine 110 is configured to enable, disable, or modify the execution of hardware features through one or more control signals to the devices of the computing resources. For example, the training engine 110 may cause different hardware features to be enabled through an operating system or other software or firmware in control of the computing resources 130. In other examples, the training engine 110 may send a direct signal through a bus or communication channel a device is configured to receive control signals from for enabling or disabling hardware features.

Some examples of hardware features that can be adjusted by different values of hardware-level performance settings include: enabling/disabling inter- or intra-communication of data among and between computing devices; levels of numerical precision the computing devices apply to perform respective operations as part of the training process; and/or enabling/disabling hardware parallelism on the computing devices. In some examples, inter- or intra-communication of data can be further adjusted, such as by rate, volume, or type of data transmitted between devices.

Hardware-level performance settings can include settings for adjusting software- or virtually-defined clusters of computing devices, with logical pathways between those computing devices. Example operations performed by the computing resources 130 during training can include calculating a dot product between a vector of input values and a matrix or tensor of weights of a neural network layer, matrix multiplication, calculating an activation function, performing convolutional operations, pooling multiple values of a feature map, etc.

Model-level performance settings can include model hyperparameters, such as the size of the machine learning model or a topology or shape of a neural network, including the size of the input the model receives. Model-level performance settings can also include training process hyperparameters for modifying the training process used by the training engine in training the machine learning model, such as a learning rate or batch size. Training process hyperparameters can also include parameters whose values control the application of various optimization processes that can be performed as part of the training process to further improve the model, such as second-order optimization methods or processes for how much functions part of the model are regularized, or how much data is normalized. Examples of training process hyperparameters can also include a learning rate or a mini-batch size, for example when the training process is mini-batch gradient descent.

For model-level performance settings, the training engine 110 can send signals interpretable by the computing resources 130 for adjusting model-level performance settings in accordance with a training schedule throughout a training period. For example, the training engine 110 may generate a program or sequence of instructions specifying adjustments to the model and/or the training process during training, and at which points or stages the adjustments should be made in accordance with model-level performance setting values of a training schedule.

The training engine 110 can generate the training schedule by searching for arrangements of values for hardware- and model-level performance settings for hardware-level or model-level features available on a platform implementing the system. As part of the generation, the training engine 110 can identify model-level and hardware-level performance settings that are complementary in achieving higher training speed or model quality, depending on the point in training at which the settings are applied.

For example, different values of hardware-level performance settings for local-only communications of neighboring computing devices in a cluster may be paired with different values of model-level performance settings in which the training engine 110 applies batch normalization or cross-replica gradient summation, to speed up training at the cost of model quality during earlier stages of training. Devices of the computing resources 130 can be logically and/or physically organized as a cluster or group of computing resources, with interconnections between at least some of the devices within a cluster to facilitate inter-device communication. Hardware-level performance settings that the training engine 110 can adjust during training can include settings for adjusting communication overhead between devices in a cluster.

As yet another example, values for hardware-level performance settings for higher numerical precision during training can be paired with values for model-level performance settings which cause the training engine 110 to apply any of a variety of second order optimization methods for better model quality, at the cost of training speed.

As yet another example, hardware-level performance settings for enabling parallel computation on certain types of accelerators, such as GPUs or TPUs can be paired with certain model-level performance settings for selecting the activation function used in training certain neural networks. For instance, ReLU may be selected as an activation function when parallel computation is selected for faster training at reduced model quality, but swish may be selected as an activation function later during training for increased model quality at the cost of reduced training speed due to reduced hardware execution parallelism.

Due to the huge space of model architectures and hardware settings, a system such as the training system 100 described herein can allow for combining hardware settings with progressive training. For example, combining hardware and model level progressive training naively can cause a catastrophic quality loss that makes the model quality too low to be useful. As another example, applying lower regularization at the model level and low precision at the hardware level at the beginning of training can cause the initial quality loss to be too low to be recovered even if regularization and numeric precision is increased significantly later in the training.

In some examples a model may be retrained according to training schedules or portions of training schedules previously used by the training engine in training the model. Retraining can include performing a number of iterations of a training process, using new training data. Example retraining can include backpropagation with gradient descent plus updating model weights for a neural network previously set from earlier training. Instead of reusing the same training schedule from the initial stage of training, the training engine 110 can apply values of hardware- and model-level performance settings of a previously-used training schedule for a later stage or point in training. In this way, values for performance settings corresponding to the current performance of the model (having already been trained) can be used by the training engine 110 to favor model quality improvement over training speed.

One example case in which a portion of a training schedule may be used as part of retraining is in retraining production machine learning models, such as models for an online search engine. The models may occasionally be retrained in view of new training data and/or model-level optimizations that may have been developed after the deployment of the production machine learning model. The training system can re-use a training schedule previously used to initially train a production machine learning model, but start retraining according to a point or stage at which model quality is emphasized over training speed.

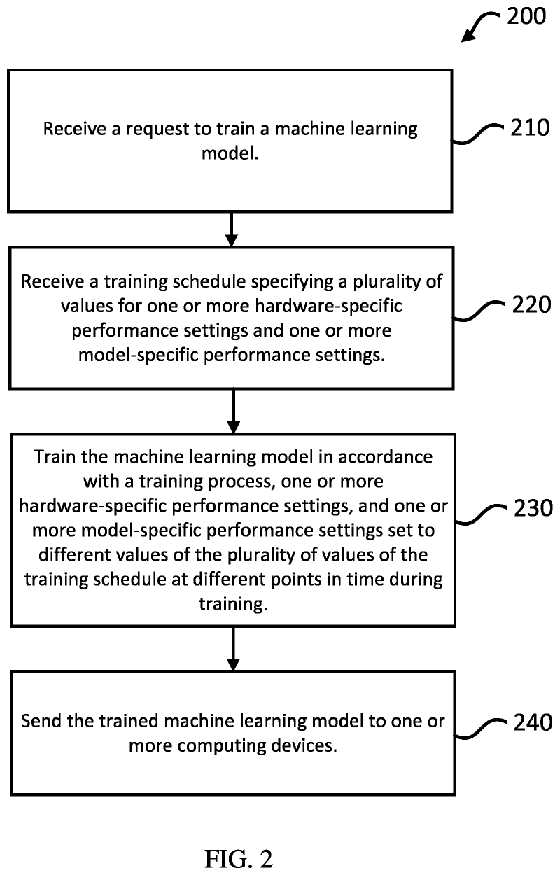

The training schedule library 120 is a collection of pre-generated training schedules stored on one or more memory devices, for example as part of a queryable database. The training schedule library 120 can be populated by training schedules generated by the training system, as described in more detail with reference to FIG. 2. In some examples, the training schedule engine 115 adds a generated training schedule to the library 120, tagging it with metadata at least partially describing the input parameters received as part of a request for training a model using the generated training schedule. In other examples, the training schedule engine 115 can populate the training schedule library 120 with one or more training schedules for commonly received machine learning models requested to be trained by the system 100. As described in more detail with reference to FIG. 3B, the training engine 110 can query the training schedule library 120 to identify a stored training schedule previously generated for a machine learning model that is the same or similar to a model currently requested by the engine 110 to be trained.

In some examples, the training system 100 can also include the neural architecture search (NAS) engine 125. As described in more detail with reference to FIG. 4, the NAS engine 125 is configured to search for neural architectures for neural networks that benefit from training according to a training schedule as described herein.

For instance, the training system 100 can receive input parameters for training a machine learning model specifying a machine learning task to perform, without specifying a particular model type. In other examples, the training system 100 can receive a request for generating a neural network based on a neural network architecture identified by the NAS engine 125.

### Example Methods

FIG. 2 is a flowchart of an example process 200 for hardware-aware progressive training of a machine learning model. A training system, such as the training system 100 of FIG. 1, can be configured to perform the process 200.

A training system receives a request to train a machine learning model, according to block 210. The request can include various types of data or metadata, including one or more input parameters. The input parameters can include the input parameters described herein with reference to FIG. 1, at least partially describing one or more of the machine learning model, the machine learning task, and computing resources available for training the machine learning model.

The training system receives a training schedule specifying a plurality of values for one or more hardware-level performance settings and one or more model-level performance settings, according to block 220. For example, the training system can generate the training schedule, as described herein with reference to FIGS. 1 and 3A. As another example, the training system can query one or more memory devices storing multiple pre-generated training schedules, as described herein with reference to FIGS. 1 and 3B.

The training system trains the machine learning model in accordance with a training process, one or more hardware-level performance settings, and one or more model-level performance settings set to different values of the plurality of values of the training schedule at different points in time during training, according to block 230. As described herein with reference to FIG. 1, the training system is configured to apply different values of both hardware- and model-level performance settings at various points during training. The training schedule can specify those points, for example as stages or other defined intervals, and the training schedule can further specify the rate at which values are changed from one end of a range, to another.

The training system sends the trained machine learning model to one or more computing devices, according to block 240. The one or more computing devices can be devices that originally requested that the machine learning model to be trained, as an example. In other examples, the one or more computing devices can be predetermined for receiving the trained machine learning model, for example as part of model deployment on a device on the edge of a network or another device of the computing platform.

FIG. 3A is a flowchart of an example process 300A for training a machine learning model to generate training schedules for hardware-aware progressive training. For purposes of description, the machine learning model trained is referred to as a training schedule machine learning model.

The training system receives one or more training examples of training schedules, according to block 310. Each example training schedule can be labeled with respective data at least partially describing one or more respective input parameters used to generate the example training schedule, a respective training speed, and respective model quality of a respective model trained using the example training schedule. The training data can be generated by hand, automatically, or a combination of both approaches.

For example, the training system can store metadata for a training schedule generated according to received input parameters, and after training the model, record its training speed and model quality. Because the training speed and model quality varies throughout training, the training system can store individual values representing the speed and quality, respectively, at different intervals in which values from the training schedule are applied to the performance settings. In addition or alternatively, the training system can compute a function of the individual training speed and model quality values, for example as an average or sum.

Using the one or more training examples, the training system trains a machine learning model, i.e., the training schedule machine learning model, to generate training schedules from one or more input parameters, according to block 320. The input parameters are the input parameters that can be received as part of a request for training a model, as described herein with reference to FIGS. 1-2. The training system can train the training schedule machine learning model in a variety of different ways, for example using some form of backpropagation with gradient descent plus model weight updates. The loss or performance function for training the training schedule machine learning model can be a function of how close the training speed or model quality at various points in the training period are to ground-truth training speeds or model qualities at those same points during training.

In other examples, the training system can be configured to search for training schedules, according to an optimization approach over a set of candidate training schedules. The search can be defined to identify a training schedule with the highest model quality and training speed through the course of training, subject to various restrictions which can be set in accordance with input parameters. For example, the restrictions can be over a certain subset of hardware-level and performance-level performance settings that are available for a given training process and set of computing resources to be used in training the model using an identified training schedule.

FIG. 3B is a flowchart of an example process for querying and applying a pre-generated training schedule from one or more memory devices storing multiple training schedules, according to aspects of the disclosure.

The training system sends a query to one or more memory devices storing a plurality of candidate training schedules, the query including data at least partially describing one or more of a machine learning model, the machine learning task, and computing resources available for training the machine learning model, according to block 330. As described herein with reference to FIG. 1, the training system can include a training engine configured to receive input parameters as part of a request to train a model, and query a training schedule library of memory devices for a previously-generated training schedule tagged with at least some of those input parameters.

The training system receives a training schedule from the plurality of candidate training schedules, in response to the query, according to block 340. For example, the received training schedule can be the training schedule that has the same or most similar metadata as the input parameters as in the query. Input parameters can be compared to predetermined similarity measures corresponding to one or more input parameters.

FIG. 4 is a flowchart of an example process for searching for neural architectures, according to aspects of the disclosure.

Aspects of the disclosure also provide for a training system configured to search a set of candidate neural network architectures for a target architecture in which hardware-aware progressive training can be applied. For example, the training system can identify a target architecture in which all or most of hardware features for a specified set of computing resources can be applied during training at different values for training speed-model quality trade-offs. The training system, as part of adjusting performance settings during training, may incur performance overhead through operations executed to cause the computing resources to train the model according to adjusted values. As another example, the training system can identify target architectures in which model-level performance settings can be adjusted with minimal performance overhead over other candidate architectures.

The training system searches for neural architectures that can benefit from continuous adjustment of hardware- and model-level performance settings during training. For example, a neural architecture which can be expanded in model size, for example measured by a number of neural network layers and/or a number of nodes in each layer, or input size with and trained on corresponding computing resources that can be scaled to accommodate the increased model or input size would benefit more during training, for example measured in higher training speeds and model quality using a training schedule of varying performance setting values, as described herein.

According to block 410 of the process 400, the training system estimates at least the training speed and model quality of a first neural network having a first candidate neural architecture of a plurality of candidate neural architectures and trained using hardware-aware progressive learning. The estimation can be part of measuring the performance of candidate neural architectures within a search space of neural architectures. The search space can include a variety of different candidate architectures, which can be filtered or adjusted based on different provided input parameters. For example, if the training system receives input parameters specifying the model type to be a convolutional neural network, then the training system can search a search space of neural architectures including at least one convolutional layer.

The training system selects the first candidate neural architecture based at least on a comparison of the estimated training speed and estimated model quality of the first neural network to respective estimated training speeds and respective estimated model qualities of one or more second neural networks. Each second neural network has a respective candidate neural architecture, according to block 420. The second neural networks can be trained according to hardware-aware progressive learning, as described herein, to identify respective training speeds and model qualities. In addition or alternatively, the training system can estimate the training speeds and model qualities.

The selection by the training system can be part of multiple iterations of selecting a candidate neural architecture, and comparing that neural architecture to a current best-known architecture. The searching can be augmented at least by using training speed and model quality from hardware-aware progressive training as indicators of the performance of different candidate models. Any of a variety of neural architecture search processes can be applied, such as a random search over a number of iterations or until finding a candidate neural architecture meeting a threshold performance value, based at least on its training speed and model quality.

When the first candidate neural architecture has been identified as the target neural architecture, the training system can proceed to train a neural network having the target neural architecture, for example as described herein with reference to FIGS. 1-2.

Aspects of the disclosure can provide for at least the following technical advantages. Generating a neural network having a neural architecture selected from NAS as described herein allows for improved utilization of hardware-aware progressive training as described herein. Neural architectures can be tailored to the computing resource environment in which they are trained, allowing for increased access to hardware features for accelerating operations of an implemented training process, as opposed to neural architectures not identified as described herein, which may be incompatible with those hardware features.

### Example Computing Environment

FIG. 5 is a block diagram of an example environment 500 for implementing the training system 100. The system 100 can be implemented on one or more devices having one or more processors in one or more locations, such as the computing platform 101 having one or more server computing devices 515 and one or more memory devices 530. User computing device 512 and the server computing device(s) 515 can be communicatively coupled to the memory devices 530 over a network 560. The memory device(s) 530 can be a combination of volatile and non-volatile memory, and can be at the same or different physical locations than the computing devices 512, 515. For example, the memory device(s) 530 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device(s) 515 can include one or more processors 513 and memory 514. The memory 514 can store information accessible by the processor(s) 513, including instructions 521 that can be executed by the processor(s) 513. The memory 514 can also include data 523 that can be retrieved, manipulated, or stored by the processor(s) 513. The memory 514 can be a type of non-transitory computer readable medium capable of storing information accessible by the processor(s) 513, such as volatile or non-volatile memory. The processor(s) 513 can include one or more central processing units (CPUs), graphic processing units (GPUs), field-programmable gate arrays (FPGAs), and/or application-specific integrated circuits (ASICs), such as tensor processing units (TPUs).

Available computing resources for the platform 101 can include one or more of the processors 513, and/or the memory 514 or memory devices 530. As described herein, computing resources for the platform 101 can be configured to implement one or more hardware features during data processing that can be enabled or modified in accordance with one or more hardware-level performance settings. The training system 100 is configured to train a machine learning model according to aspects of the disclosure, on computing resources of the platform 101.

The instructions 521 can include one or more instructions that when executed by the processor(s) 513, cause the processor(s) 513 to perform actions defined by the instructions. The instructions 521 can be stored in object code format for direct processing by the processor(s) 513, or in other formats, including interpretable scripts or collections of independent source code modules that are interpreted on demand or compiled in advance. The instructions 521 can include instructions for implementing the training system 100 consistent with aspects of this disclosure. The training system 100 can be executed using the processor(s) 513, and/or using other processors remotely located from the server computing device(s) 515.

The data 523 can be retrieved, stored, or modified by the processor(s) 513 in accordance with the instructions 521. The data 523 can be stored in computer registers, in a relational or non-relational database as a table having a plurality of different fields and records, or as JSON, YAML, proto, or XML documents. The data 523 can also be formatted in a computer-readable format such as, but not limited to, binary values, ASCII or Unicode. Moreover, the data 523 can include information sufficient to identify relevant information, such as numbers, descriptive text, proprietary codes, pointers, references to data stored in other memories, including other network locations, or information that is used by a function to calculate relevant data.

The user computing device 512 can also be configured similar to the server computing device(s) 515, with one or more processors 516, memory 517, instructions 518, and data 519. The user computing device 512 can also include a user output 526, and a user input 524. The user input 524 can include any appropriate mechanism or technique for receiving input from a user, such as keyboard, mouse, mechanical actuators, soft actuators, touchscreens, microphones, and sensors.

The server computing device(s) 515 can be configured to transmit data to the user computing device 512, and the user computing device 512 can be configured to display at least a portion of the received data on a display implemented as part of the user output 526. The user output 526 can also be used for displaying an interface between the user computing device 512 and the server computing device(s) 515. The user output 526 can alternatively or additionally include one or more speakers, transducers or other audio outputs, a haptic interface or other tactile feedback that provides non-visual and non-audible information to the user of the computing device 512.

Although FIG. 5 illustrates the processors 513, 516 and the memories 514, 517 as being within the computing devices 515, 512, components described in this specification, including the processors 513, 516 and the memories 514, 517 can include multiple processors and memories that can operate in different physical locations and not within the same computing device. For example, some of the instructions 521, 518 and the data 523, 519 can be stored on a removable SD card and others within a read-only computer chip. Some or all of the instructions and data can be stored in a location physically remote from, yet still accessible by, the processors 513, 516. Similarly, the processors 513, 516 can include a collection of processors that can perform concurrent and/or sequential operation. The computing devices 515, 512 can each include one or more internal clocks providing timing information, which can be used for time measurement for operations and programs run by the computing devices 515, 512.

The server computing device(s) 515 can be configured to receive requests to process data from the user computing device 512. For example, the platform 101 can be configured to provide a variety of services to users, through various user interfaces and/or APIs exposing the platform services. One or more services can be a machine learning framework or a set of tools for generating neural networks or other machine learning models according to a specified task and training data. The user computing device 512 may receive and transmit data specifying target computing resources to be allocated for training and deploying a neural network to perform a particular machine learning task.

For example, the server computing device(s) 515 can be configured to receive a request specifying, for example, a set of training data; the type of model to train, such as a deep neural network, a recurrent neural network, and a convolutional neural network; and the type of machine learning task the model will be trained to perform. The request can optionally specify more or fewer parameters, as described herein.

The devices 512, 515 can be capable of direct and indirect communication over the network 560. The devices 515, 512 can set up listening sockets that may accept an initiating connection for sending and receiving information. The network 560 itself can include various configurations and protocols including the Internet, World Wide Web, intranets, virtual private networks, wide area networks, local networks, and private networks using communication protocols proprietary to one or more companies. The network 560 can support a variety of short- and long-range connections. The short- and long-range connections may be made over different bandwidths, such as 2.402 GHz to 2.480 GHz, 2.4 GHz and 5 GHz; or with a variety of communication standards, such as standards for wireless broadband communication. The network 560, in addition or alternatively, can also support wired connections between the devices 512, 515, including over various types of Ethernet connection.

It is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

### Example Machine Learning Tasks

As described herein, aspects of the disclosure provide for hardware-aware progressive training of a machine learning model to perform a respective machine learning task. Examples of machine learning tasks follow.

As an example, the input to the machine learning model to be trained can be in the form of images or videos. A machine learning model can be trained to extract, identify, and generate features as part of processing a given input, for example as part of a computer vision task. A machine learning model trained to perform this type of machine learning task can be trained to generate an output classification from a set of different potential classifications. In addition or alternatively, the machine learning model can be trained to output a score corresponding to an estimated probability that an identified subject in the image or video belongs to a certain class.

As another example, the input to the machine learning model can be data files corresponding to a particular format, such as HTML or XML files, word processing documents, or formatted metadata obtained from other types of data, such as metadata for image files. A machine learning task in this context can be to classify, score, or otherwise predict some characteristic about the received input. For example, a machine learning model can be trained to predict the probability that received input includes text relating to a particular subject. Also as part of performing a particular task, the machine learning model can be trained to generate text predictions, for example as part of a tool for auto-completion of text in a document as the document is being composed. A machine learning model can also be trained for predicting a translation of text in an input document to a target language, for example as a message is being composed.

Other types of input documents can be data relating to characteristics of a network of interconnected devices. These input documents can include activity logs, as well as records concerning access privileges for different computing devices to access different sources of potentially sensitive data. A machine learning model can be trained for processing these and other types of documents for predicting on-going and future security breaches to the network. For example, the machine learning model can be trained to predict intrusion into the network by a malicious actor.

As another example, the input to a machine learning model can be audio input, including streamed audio, pre-recorded audio, and audio as part of a video or other source or media. A machine learning task in the audio context can include speech recognition, including isolating speech from other identified sources of audio and/or enhancing characteristics of identified speech to be easier to hear. A machine learning model can be trained to predict an accurate translation of input speech to a target language, for example in real-time as part of a translation tool.

In addition to data input, including the various types of data described herein, a machine learning model can also be trained to process features corresponding to given input. Features are values, such as numerical values or categorical values, which relate to some characteristic of the input. For example, in the context of an image, a feature of the image can relate to the RGB value for each pixel in the image. A machine learning task in the image/video context can be to classify contents of an image or video, for example for the presence of different people, places, or things. Machine learning models can be trained to extract and select relevant features for processing to generate an output for a given input, and can also be trained to generate new features based on learned relationships between various characteristics of input data.

Aspects of this disclosure can be implemented in digital circuits, computer-readable storage media, as one or more computer programs, or a combination of one or more of the foregoing. The computer-readable storage media can be non-transitory, for example, as one or more instructions executable by one or more computing devices and stored on one or more tangible memory devices.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program, engine, or module includes one or more program instructions, that when executed by one or more computing devices, such as one or more processors, causes the one or more computing devices to perform the one or more operations.

While operations shown in the drawings and recited in the claims are shown in a particular order, it is understood that the operations can be performed in different orders than shown, and that some operations can be omitted, performed more than once, and/or be performed in parallel with other operations. Further, the separation of different system components configured for performing different operations should not be understood as requiring the components to be separated. The components, modules, programs, and engines described can be integrated together as a single system, or be part of multiple systems.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the examples should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A system, comprising:
one or more processors configured to:
receive a request to train a machine learning model;
receive a training schedule specifying a plurality of values for one or more hardware-level performance settings and one or more model-level performance settings;
train the machine learning model in accordance with a training process, one or more hardware-level performance settings, and one or more model-level performance settings set to different values of the plurality of values of the training schedule at different points in time during training; and
in response to receipt of the request, send the trained machine learning model to one or more computing devices.

2. The system of claim 1, wherein the one or more model-level performance settings comprise one or more of:
an input data size for input data to the machine learning model,
one or more model hyperparameters specifying the size or shape of the machine learning model, and
one or more training process hyperparameters modifying the training process implemented by the one or more processors for training the machine learning model.

3. The system of claim 1, wherein the one or more hardware-level performance settings comprise settings for adjusting intra- or inter-data communication between the one or more processors.

4. The system of claim 3,
wherein the one or more processors comprise a plurality of processors logically or physically grouped into a plurality of groups, and
wherein the one or more hardware-level performance settings comprise settings for a rate of inter-data communication between processors in different groups.

5. The system of claim 3, wherein the one or more hardware-level performance settings comprise settings for adjusting numerical precision of operations performed by the one or more processors while training the machine learning model in accordance with the training process.

6. The system of claim 3, wherein the one or more hardware-level performance settings comprise settings for enabling or disabling hardware parallelism among the one or more processors while training the machine learning model in accordance with the training process.

7. The system of claim 1, wherein in training the machine learning model, the one or more processors are further configured to:
set the one or more hardware-level and model-level performance settings to first values of the plurality of values of the training schedule; and
at a first point in time after initiation of the training of the machine learning model, adjust the one or more hardware-level and one or more model-level performance settings to second values of the plurality of values different from the first values.

8. The system of claim 1, wherein in receiving the training schedule, the one or more processors are further configured to generate a training schedule using a training schedule machine learning model, wherein the training schedule machine learning model is:
trained to generate training schedules from one or more input parameters at least partially describing one or more of the machine learning model, the machine learning task, and computing resources available for training the machine learning model; and
trained using one or more training examples of training schedules, each example training schedule labeled with respective data at least partially describing one or more respective input parameters used to generate the example training schedule, the training speed, and the model quality of a respective machine learning model trained in accordance with the training process and the example training schedule.

9. The system of claim 1, wherein the machine learning model is a neural network having a neural architecture selected from a plurality of candidate neural architectures, the selection of the neural architecture based at least partially on a comparison of estimated respective training speeds and respective model qualities of neural networks, the neural network being trained in accordance with the training process and a respective training schedule and having a respective candidate neural architecture of the plurality of candidate neural architectures.

10. The system of claim 1, wherein in receiving the training schedule, the one or more processors are further configured to:
send a query to one or more memory devices storing a plurality of candidate training schedules, the query comprising data at least partially describing one or more of the machine learning model, the machine learning task, and computing resources available for training the machine learning model; and
receive the training schedule from the plurality of candidate training schedules in response to the query.

11. A method, comprising:
receiving, by one or more processors, a request to train a machine learning model, the one or more processors configured to train the machine learning model in accordance with one or more hardware-level performance settings and one or more model-level performance settings;
receiving, by the one or more processors, a training schedule specifying a plurality of values for the one or more hardware-level performance settings and the one or more model-level performance settings;
training, by the one or more processors, the machine learning model in accordance with a training process and the one or more hardware-level performance settings and one or more model-level performance settings set to different values of the plurality of values of the training schedule at different points in time during training; and
in response to receiving the request, sending, by the one or more processors, the trained machine learning model to one or more computing devices.

12. The method of claim 11, wherein the one or more model-level performance settings comprise one or more of:
an input data size for input data to the machine learning model,
one or more model hyperparameters specifying the size or shape of the machine learning model, and
one or more training process hyperparameters modifying the training process implemented by the one or more processors for training the machine learning model.

13. The method of claim 11, wherein the one or more hardware-level performance settings comprise settings for adjusting intra- or inter-data communication between the one or more processors.

14. The method of claim 13,
wherein the one or more processors comprise a plurality of processors logically or physically grouped into a plurality of groups, and
wherein the one or more hardware-level performance settings comprise settings for a rate of inter-data communication between processors in different groups.

15. The method of claim 13, wherein the one or more hardware-level performance settings comprise settings for enabling or disabling hardware parallelism among the one or more processors while training the machine learning model in accordance with the training process.

16. The method of claim 11, wherein receiving the training schedule comprises generating, by the one or more processors, a training schedule using a training schedule machine learning model, wherein the training schedule machine learning model is:
trained to generate training schedules from one or more input parameters at least partially describing one or more of the machine learning model, the machine learning task, and computing resources available for training the machine learning model; and
trained using one or more training examples of training schedules, each example training schedule labeled with respective data at least partially describing one or more respective input parameters used to generate the example training schedule, the training speed, and the model quality of a respective machine learning model trained in accordance with the training process and the example training schedule.

17. The method of claim 11, wherein the machine learning model is a neural network having a neural architecture selected from a plurality of candidate neural architectures, the selection of the neural architecture based at least partially on comparison of estimated respective training speeds and respective model qualities of neural networks, the neural network being trained in accordance with the training process and a respective training schedule and having a respective candidate neural architecture of the plurality of candidate neural architectures.

18. The of claim 11, wherein receiving the training schedule comprises:
sending, by the one or more processors, a query to one or more memory devices storing a plurality of candidate training schedules, the query comprising data at least partially describing one or more of the machine learning model, the machine learning task, and computing resources available for training the machine learning model; and
receiving, by the one or more processors, the training schedule from the plurality of candidate training schedules in response to the query.

19. The method of claim 11, wherein training the machine learning model further comprises:
setting, by the one or more processors, the one or more hardware-level and model-level performance settings to first values of the plurality of values of the training schedule; and
at a first point in time after initiating the training of the machine learning model, adjusting, by the one or more processors, the one or more hardware-level and one or more model-level performance settings to second values of the plurality of values different from the first values.

20. One or more non-transitory computer-readable storage media encoded with instructions that when executed by one or more processors configured to train a machine learning model in accordance with one or more hardware-level performance settings and one or more model-level performance settings, cause the one or more processors to perform operations comprising:
receiving a request to train a first machine learning model;
receiving a training schedule specifying a plurality of values for the one or more hardware-level performance settings and the one or more model-level performance settings;
training the first machine learning model in accordance with a training process and the one or more hardware-level performance settings and one or more model-level performance settings set to different values of the plurality of values of the training schedule at different points in time during training; and
in response to receiving the request, sending the trained first machine learning model to one or more computing devices.
